(19) United States
(12) Patent Application Publication
(10) Pub. No.: US 2009/0235288 A1
(43) Pub. Date: Sep. 17, 2009

(54) Disk Device

(76) Inventors: Hideo Ito, Saitama (JP); Koichi Tokumoto, Saitama (JP); Toshiyuki Tanaka, Saitama (JP)

Correspondence Address: FOLEY AND LARDNER LLP;SUITE 500, 3000 K STREET NW, WASHINGTON, DC, 20007, US

(21) Appl. No.: 12/086,192

(22) PCT Filed: Dec. 7, 2006
(86) PCT No.: PCT/JP2006/324479

§ 371 Date: Jul. 8, 2008

(30) Foreign Application Priority Data
Dec. 9, 2005 (JP) 2005-356466

(51) Int. Cl. G11B 17/04

(52) U.S. Cl. 720/601; G9B/17.013

(57) ABSTRACT

A disk drive includes a chassis and an upper case forming a disk drive body, a door element, and a moving-side cam mechanism being a door-element moving unit. The chassis has an opening portion through which a disk is loaded or unloaded and which is formed in a loading/unloading direction of the disk. The door element is supported by the disk drive body so as to be movable in the loading/unloading direction with respect to the opening portion and is supported by the chassis so as to be movable in an opening/closing direction of opening or closing the opening portion. The moving-side cam mechanism moves the door element blocking the opening portion, in the unloading direction of the loading/unloading direction and moves the door element separated from the opening portion, in a direction of opening the opening portion, in association with an unloading operation of the disk.

### TECHNICAL FIELD

The present invention relates to a disk drive and, more particularly, to a disk drive including a door element that opens or closes in association with a loading/unloading operation of a disk.

### BACKGROUND ART

A disk drive is required for loading and unloading a disk into and from a disk drive body to perform at least either one of reproduction of information recorded in the disk and recording of information in the disk. To load or unload the disk, an ordinary disk drive includes a tray that moves from a disk mounting position where the disk is mounted on the tray to a disk reproducing position where the disk mounted thereon is reproduced or recorded by the disk drive. Therefore, the loading of the disk is implemented by mounting the disk on the tray located at the disk mounting position and moving the tray with the disk to the disk reproducing position. The unloading of the disk is implemented by moving the tray with the disk from the disk reproducing position to the disk mounting position.

In conventional disk drives, an opening portion is formed in a disk drive body in a loading/unloading direction so as to load or unload a disk. Consequently, dust such as dirt and other foreign particles may enter the disk drive body from the outside. The dust adversely affects, for example, reading of recorded information from the disk by a pickup or writing of information onto the disk thereby, and this may cause a reading failure and a writing failure in the pickup to occur. The conventional disk drive is therefore provided with a door element that opens or closes in association with a loading/unloading operation of the disk as described in Patent document 1.

The disk drive as shown in Patent document 1 is configured so that the door element reciprocates in a thickness direction of the disk drive (vertical direction) in association with the loading/unloading operation of the disk by the tray and with a lifting operation of a traverse mechanism, to open or close the opening portion of the disk drive body. In the disk drive, the door element closes when the tray is located at the disk reproducing position. Consequently, the door element opens only when the tray is loaded or unloaded, and this allows prevention of dust from entering the disk drive body through the opening portion thereof.

Patent document 1: Japanese Patent Application Laid-Open No. H10-208347

### DISCLOSURE OF INVENTION

### Problem to be Solved by the Invention

However, in the disk drive as shown in Patent document 1, the door element moves in parallel with the opening portion, and, because of this, a space is formed between the door element and the opening portion even if the door element is located at a position facing the opening portion. Moreover, the door element is rotatably supported in the conventional disk drive and the opening portion of the disk drive body is opened or closed by swinging the door element in the rotating direction. Also in this case, a space is formed between the door element and the opening portion to prevent the door element from contacting the opening portion upon swinging of the door element. Therefore, dust prevention is insufficient because of the space formed therebetween.

The present invention has been achieved to solve the problem as one example of solutions, and it is an object of the present invention to provide the disk drive capable of reliably providing dust prevention.

### Means for Solving Problem

A disk drive according to one aspect of the present invention includes a disk drive body in which an opening portion is formed in a loading/unloading direction of a disk, and into or from which the disk is loaded or unloaded through the opening portion, a door element supported by the disk drive body so as to be movable in the loading/unloading direction with respect to the opening portion and movable in an opening/closing direction of opening or closing the opening portion, a door-element moving unit that moves the door element, which blocks the opening portion, in the unloading direction of the loading/unloading direction and moves the door element, which is separated from the opening portion, in a direction of opening the opening portion of the opening/closing direction, in association with an unloading operation of the disk; and a drive element that is supported in the disk drive body so as to be movable in one direction, and moves in association with the loading/unloading operation of the disk, wherein the door-element moving unit includes a moving-side cam mechanism formed of at least moving-side cam pins and moving-side cam grooves which are separately formed in the drive element and the door element respectively, the moving-side cam pins reciprocate within the moving-side cam grooves respectively by movement of the drive element, and the moving-side cam grooves include at least step regions of which a depth from opening faces of the moving-side cam grooves is formed differently from a depth of other regions, and through which the moving-side cam pins pass to allow the door element in contact with the opening portion to move in the loading/unloading direction, and slope regions that are formed so as to be adjacent to the step regions and slope with respect to a moving direction of the drive element, and through which the moving-side cam pins pass to allow the door element separated from the opening portion to move in the opening/closing direction.

Further, a disk drive according to another aspect of the present invention includes a disk drive body into or from which a disk is loaded or unloaded, a door element supported by the disk drive body so as to be movable in a loading/unloading direction with respect to an opening portion formed in an electronic device that houses therein the disk drive body and movable in an opening/closing direction of opening or closing the opening portion, a door-element moving unit that moves the door element, which blocks the opening portion, in the loading direction of the loading/unloading direction and moves the door element, which is separated from the opening portion, in a direction of opening the opening portion of the opening/closing direction, in association with an unloading operation of the disk, and a drive element that is supported in the disk drive body so as to be movable in one direction, and moves in association with the loading/unloading operation of the disk, wherein the door-element moving unit includes a moving-side cam mechanism formed of at least moving-side cam pins and moving-side cam grooves which are separately formed in the drive element and the door element respectively, the moving-side cam pins reciprocate within the moving-side cam grooves respectively by movement of the drive element, and the moving-side cam grooves include at least step regions of which a depth from opening faces of the moving-side cam grooves is formed differently from a depth of other regions, and through which the moving-side cam pins pass to allow the door element in contact with the opening portion to move in the loading/unloading direction, and slope regions that are formed so as to be adjacent to the step regions and slope with respect to a moving direction of the drive element, and through which the moving-side cam pins pass to allow the door element separated from the opening portion to move in the opening/closing direction.

### EFFECT OF THE INVENTION

The disk drive according to the present invention allows reliable dust prevention.

### BRIEF DESCRIPTION OF DRAWINGS

FIG. 1A is a schematic (plan view) of a configuration example of a disk drive according to Example 1;

FIG. 1B is a schematic (front view) of the configuration example of the disk drive according to Example 1;

FIG. 1C is a schematic (side view) of the configuration example of the disk drive according to Example 1;

FIG. 2A is a schematic (plan view) of a configuration example of a chassis and an upper case;

FIG. 2B is a schematic (front view) of the configuration example of the chassis and the upper case;

FIG. 3A is a schematic (plan view) of a configuration example of a tray;

FIG. 3B is a schematic (front view) of the configuration example of the tray;

FIG. 4A is a schematic (plan view) of a configuration example of a door element;

FIG. 4B is a schematic (front view) of the configuration example of the door element;

FIG. 4C is a schematic (side view) of the configuration example of the door element;

FIG. 4D is an A-A cross section of FIG. 4B;

FIG. 5A is a schematic for explaining an operation of the disk drive according to Example 1;

FIG. 5B is a schematic for explaining the operation of the disk drive according to Example 1;

FIG. 6A is a schematic of another configuration example of the disk drive according to Example 1;

FIG. 6B is a schematic of another configuration example of the disk drive according to Example 1;

FIG. 7A is a schematic (front view) of a configuration example of a disk drive according to Example 2;

FIG. 7B is a schematic (side view) of the configuration example of the disk drive according to Example 2;

FIG. 8A is a schematic (plan view) of a configuration example of a door element;

FIG. 8B is a schematic (front view) of the configuration example of the door element;

FIG. 8C is a schematic (side view) of the configuration example of the door element;

FIG. 8D is a C-C cross section of FIG. 8B;

FIG. 9A is a schematic for explaining an operation of the disk drive according to Example 2; and

FIG. 9B is a schematic for explaining the operation of the disk drive according to Example 2.

### EXPLANATIONS OF LETTERS OR NUMERALS

1-1, 1-2 Disk drive
2 Chassis
21 Installation space
21a Sliding groove
21b, c Bearing
22 Main cam
22a Sliding pin
23 Traverse mechanism
24 Driven element
24a, b Supporting shaft
25 Lift cam mechanism
25a, b Lift cam pin
26a to d Fixing hole
27a, b Rotating shaft
27c, d Locking boss
28a Chassis-side contact face (Opening-side contact face)
28b, c Sliding boss
28d Concave portion
3 Upper case
31a to d Fixing hole
32 Case-side contact face (Opening-side contact face)
33 Concave portion
4 Tray
41 Mount portion
41a, b Mounting-use concave portion
41c Positioning pin
42 Sliding element
5 Door element
51 Front-face portion
51a Back side (Door-side contact face)
51b Surface
52, 53 Arm portion
54a, 54b Sliding bearing hole
55a, 55b Locking boss
56a, 56b Sliding groove
57 Convex portion
58 Flange portion
6-1, 6-2 Moving-side cam mechanism
61, 62 Moving-side cam pin
63 to 66 Moving-side cam groove
7 Control-side cam mechanism
71, 72 Control-side cam pin
73 to 76 Control-side cam groove
9a, 9b Elastic element
10 Cushion element
S1, S2 Opening portion

### BEST MODE(S) FOR CARRYING OUT THE INVENTION

Exemplary embodiments of the present invention are explained in detail below with reference to the accompanying drawings. It is noted that the present invention is not limited by the embodiments and examples explained below. Components in the embodiments and the examples include those which persons skilled in the art can easily think of or include substantial equivalents. The examples explain a disk drive capable of reproducing information recorded in either one of a disk contained in a cartridge and a disk not contained in a cartridge, or capable of recording information in either one of the disks, however, the present invention is not limited to these examples. For example, the present invention may be a disk drive capable of reproducing information recorded only in a disk contained in a cartridge or only in a disk not contained in a cartridge, or capable of recording information in the disk.

### First Embodiment

A disk drive according to a first embodiment includes a disk drive body, a door element, and a door-element moving unit. The disk drive body is configured so that a disk is loaded thereinto or unloaded therefrom and an opening portion is formed in a loading/unloading direction of the disk. The door element is supported by the disk drive body so as to be movable in the loading/unloading direction with respect to the opening portion, and also supported thereby so as to be movable in an opening/closing direction of opening or closing of the opening portion. The door-element moving unit moves the door element, which blocks the opening portion, in the unloading direction of the loading/unloading direction and moves the door element, which is separated from the opening portion, in the direction of opening of the opening portion of the opening/closing direction, in association with the unloading operation of the disk.

The disk drive according to the first embodiment is based on the above configuration, and thus, upon unloading of the disk, for example, when the disk is unloaded by a tray, the door element separates from the blocked opening portion by moving in the unloading direction, and opens the opening portion by moving in the opening direction. On the other hand, upon loading of the disk, for example, when the disk is loaded by the tray, the door element moves in the closing direction and then moves in the loading direction to block the opening portion. Consequently, the door element maintains the state where the opening portion is blocked at any time other than the time of loading or unloading the disk. With this feature, dust prevention for the inner side of the disk drive can be reliably achieved.

### Second Embodiment

A disk drive according to a second embodiment includes a disk drive body, a door element, and a door-element moving unit. The disk drive body is configured so that a disk is loaded thereinto or unloaded therefrom. The door element is supported by the disk drive body so as to be movable in the loading/unloading direction with respect to an opening portion formed in an electronic device in which the disk drive body is housed, and also supported thereby so as to be movable in an opening/closing direction of opening or closing of the opening portion. The door-element moving unit moves the door element, which blocks the opening portion, in the loading direction of the loading/unloading direction and moves the door element, which is separated from the opening portion, in the direction of opening of the opening portion of the opening/closing direction, in association with the unloading operation of the disk.

The disk drive according to the second embodiment is based on the above configuration, and thus, upon unloading of the disk, for example, when the disk is unloaded by the tray, the door element separates from the opening portion formed in the electronic device in contact with the door element by moving in the loading direction, and opens the opening portion by moving in the opening direction. On the other hand, upon loading of the disk, for example, when the disk is loaded by the tray, the door element moves in the closing direction and then moves in the unloading direction to block the opening portion formed in the electronic device. Consequently, the door element maintains the state where the opening portion is blocked at any time other than the time of loading or unloading the disk. With this feature, dust prevention for not only the inner side of the disk drive but also the inner side of the electronic device that houses therein the disk drive can be reliably achieved.

### Third Embodiment

A disk drive according to a third embodiment based on the disk drive according to the first embodiment or the second embodiment further includes a drive element that is supported in the disk drive body so as to be movable in one direction and moves in association with the loading/unloading operation of a disk. Furthermore, the door-element moving unit is provided with moving-side cam pins and moving-side cam grooves which are separately formed in the drive element and the door element respectively. The moving-side cam pin reciprocates within the moving-side cam groove in association with moving of the drive element. The moving-side cam groove has at least a step region and a slope region. The step region is formed so that a depth from the opening face of the moving-side cam groove is different from that of other regions, and passage of the moving-side cam pin through the step region allows the door element in contact with the opening portion to move in the loading/unloading direction. The slope region is formed so as to be adjacent to the step region and slope in a moving direction of the drive element, and passage of the moving-side cam pin through the slope region allows the door element separated from the opening portion to move in the opening/closing direction.

The disk drive according to the third embodiment based on the above configuration includes the drive element such as a lift cam mechanism in a space with a driven element. And by moving a main cam that lifts up and down a traverse mechanism mounted on the driven element in one direction, a moving-side cam mechanism which is the door-element moving unit moves the door element in two directions, such as the loading/unloading direction of the door element with respect to the opening portion and the opening/closing direction of opening or closing of the opening portion. Therefore, dust prevention for the inner side of the disk drive body or of the electronic device can be reliably achieved with a simple configuration. Moreover, the moving-side cam mechanism is formed between the drive element usually provided in the disk drive and the door element, and thus there is no need to provide a new element that moves the door element in two directions in the disk drive body. With this feature, the disk drive can be minimized.

### Fourth Embodiment

In a disk drive according to a fourth embodiment based on the disk drive according to any one of the first to the third embodiments, the door-element moving unit further includes a movement control unit that controls movement of the door element in a direction toward the opening portion upon movement of the door element in the opening/closing direction.

The disk drive according to the fourth embodiment is based on the above configuration, and thus, when the door element is to move in the opening/closing direction, the movement control unit allows movement of the door element in the opening/closing direction while the door element is kept away from the opening portion. Therefore, when moving in the opening/closing direction, the door element can be prevented from contacting the opening portion and other elements of the disk drive body.

### Fifth Embodiment

A disk drive according to a fifth embodiment based on the disk drive according to any one of the first to the fourth embodiments includes fitting units provided in a door-side contact face of the door element that blocks the opening portion and an opening-side contact face that faces the door-side contact face when the door element blocks the opening portion. When the door element blocks the opening portion or when the door-side contact face comes into contact with the opening-side contact face, one of the fitting units fits into the other to surround the opening portion.

The disk drive according to the fifth embodiment is based on the above configuration, and thus, when the door element blocks the opening portion, one of the fitting units fits into the other so that the fitting units surround the opening portion, and it is thereby possible to further prevent dust from entering the disk drive through a space between the door element and the opening portion. Therefore, dust prevention for the inner side of the disk drive body or of the electronic device that houses therein the disk drive body can be more reliably achieved.

### Sixth Embodiment

A disk drive according to a sixth embodiment based on the disk according to any one of the first to the fourth embodiments includes a cushion element provided in either one of the door-side contact face of the door element that blocks the opening portion and the opening-side contact face that faces the door-side contact face when the door element blocks the opening portion. The cushion element surrounds the opening portion by coming into contact with the door-side contact face and the opening-side contact face.

The disk drive according to the sixth embodiment is based on the above configuration, and thus, when the door element is to block the opening portion, the cushion element comes into contact with the door element and the opening portion to surround the opening portion. It is thereby possible to further prevent dust from entering the disk drive through a space between the door element and the opening portion. Therefore, dust prevention for the inner side of the disk drive body or of the electronic device that houses therein the disk drive body can be more reliably achieved.

### Example 1

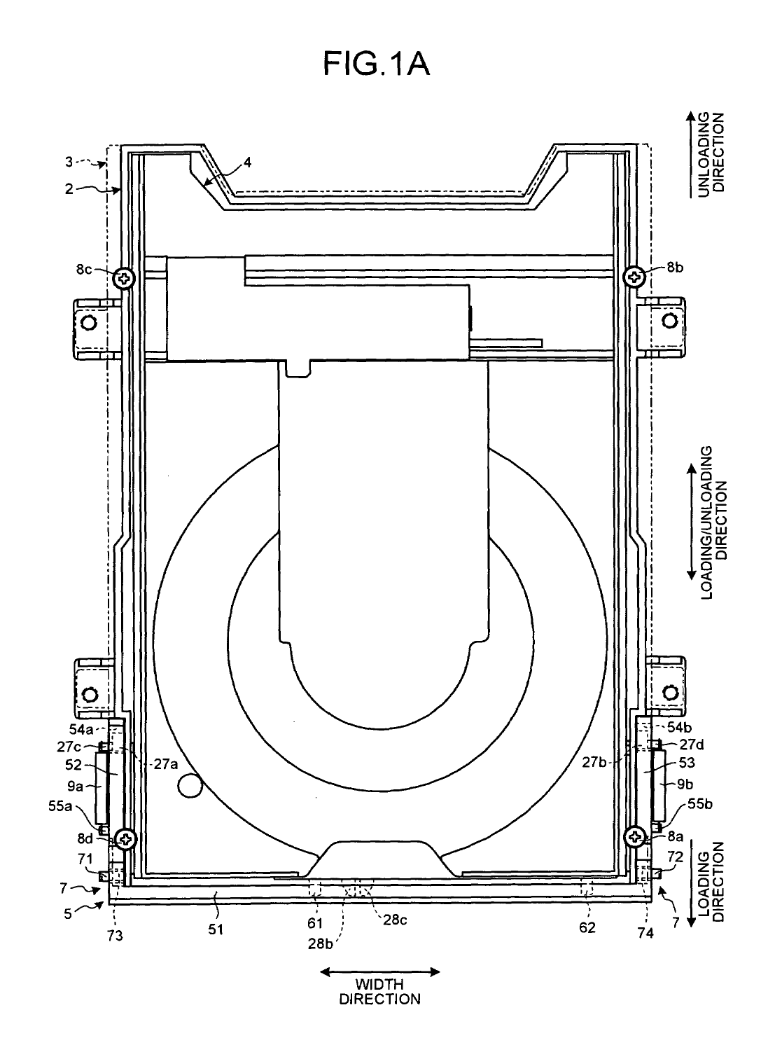

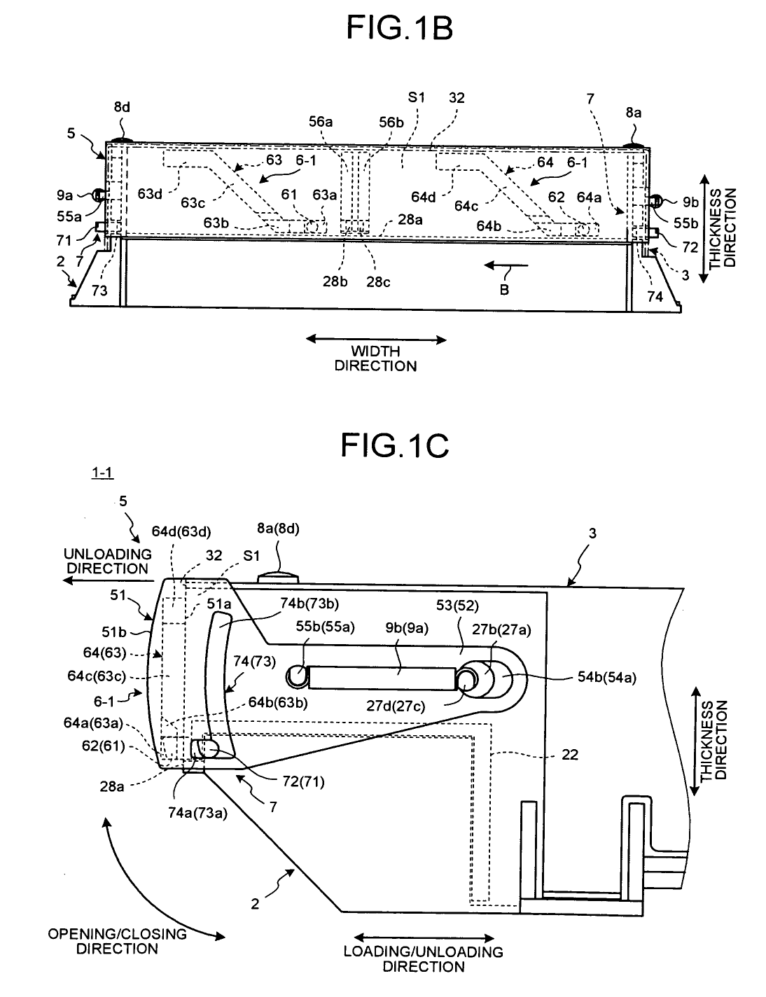

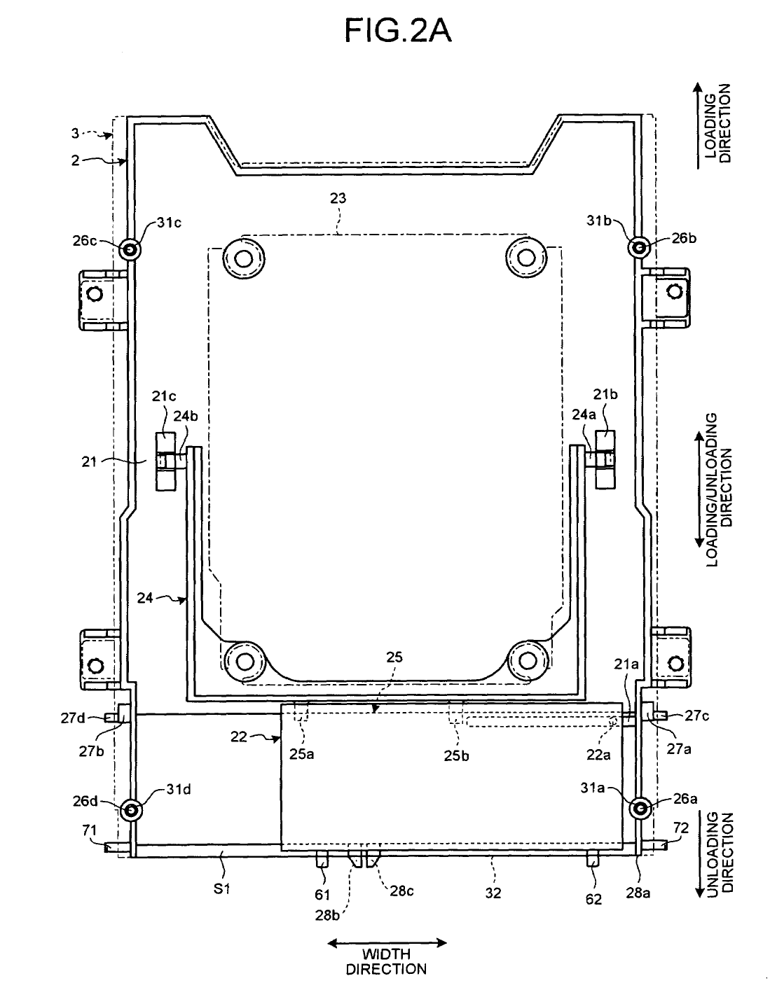

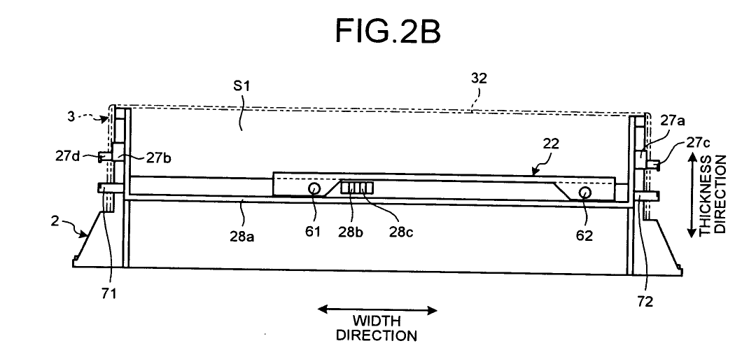

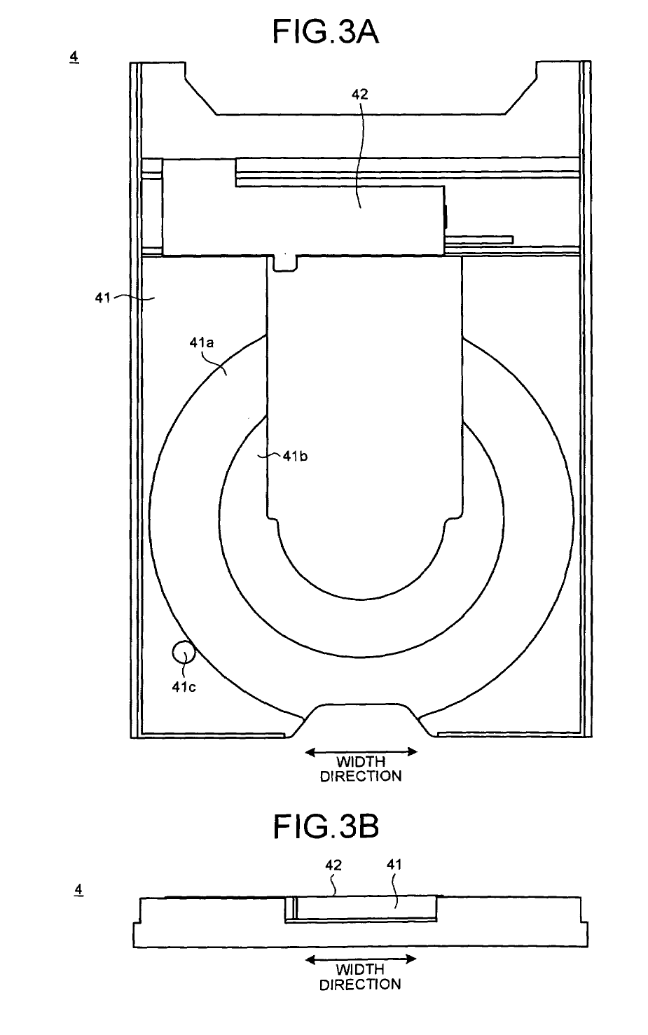

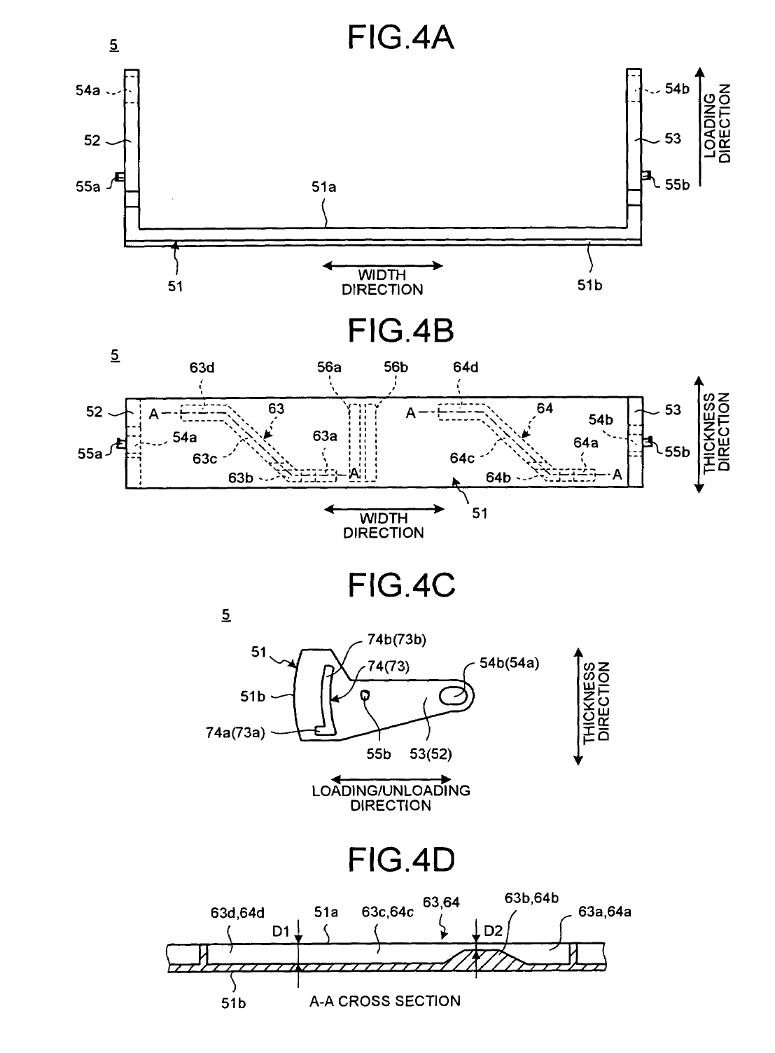

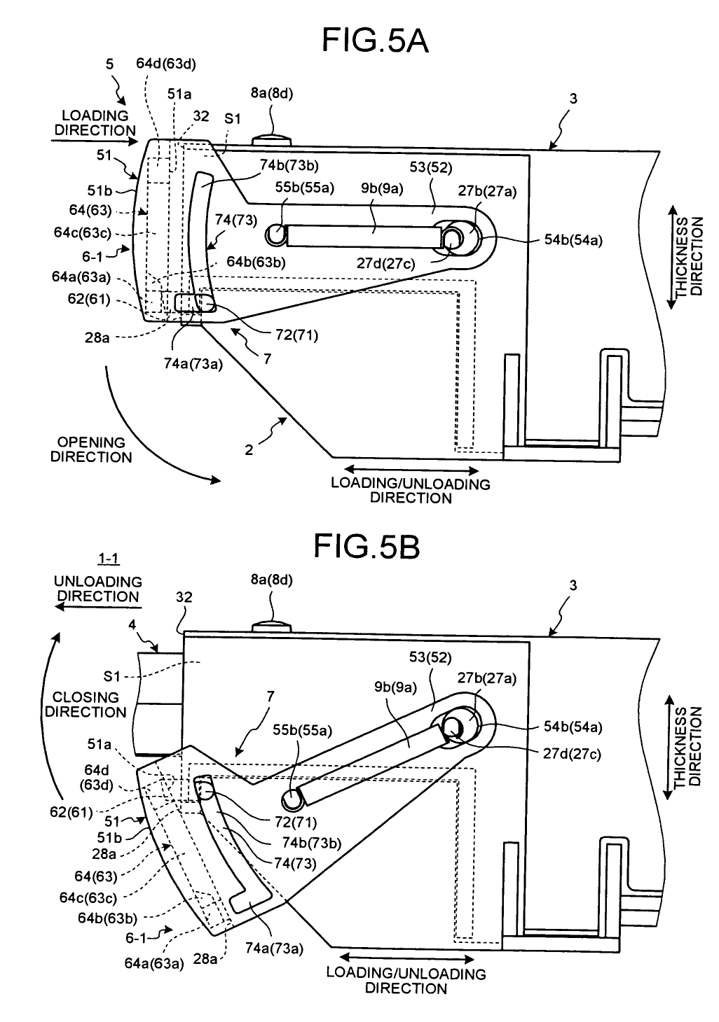

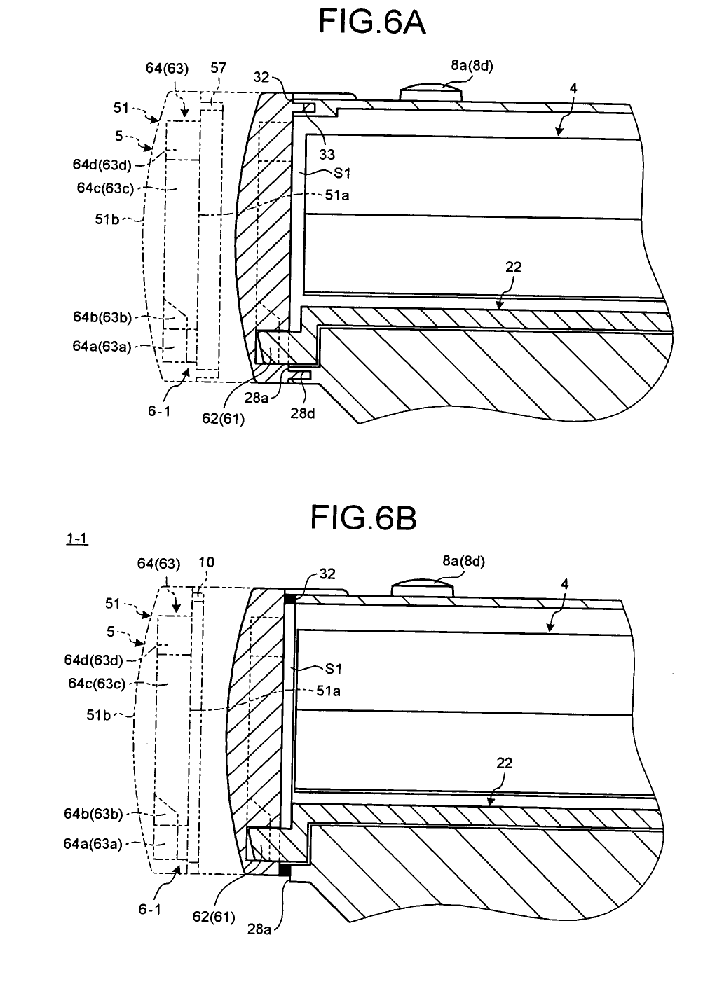

FIGS. 1A to 1C are cross sections of a main portion of a disk drive according to Example 1. FIGS. 2A and 2B are schematics of a configuration example of a chassis and an upper case. FIGS. 3A and 3B are schematics of a configuration example of a tray. FIGS. 4A to 4D are schematics of a configuration example of a door element. FIGS. 5A and 5B are schematics for explaining an operation of the disk drive according to Example 1. FIGS. 6A and 6B are schematics of another configuration example of the disk drive according to Example 1.

Example 1 explains the disk drive that is provided with a tray capable of loading/unloading both a disk contained in a cartridge and a disk not contained in a cartridge (hereinafter, simply “disk”), and that can reproduce information stored in a loaded disk and record information in the disk. It is noted that the present invention is not limited by the disk drive, and thus any disk drive may be used if it can load/unload the disk and includes a door element that opens or closes in association with a loading/unloading operation of the disk. The disk mentioned here includes optical discs such as DVD (Digital Versatile Disk), CD (Compact Disk), BD (Blue-ray Disk), and HD DVD (High Definition Digital Versatile Disk). The loading of the disk mentioned here indicates movement of the tray from a disk mounting position to a disk reproducing position. On the other hand, unloading of the disk indicates movement of the tray from the disk reproducing position to the disk mounting position.

As shown in FIGS. 1A to 1C, a disk drive 1-1 includes a chassis 2 that forms a disk drive body, an upper case 3, a tray 4, a door element 5, a moving-side cam mechanism 6-1, and a control-side cam mechanism 7. The tray 4 is supported and housed between the chassis 2 and the upper case 3 so as to be movable from the disk mounting position (not shown) where the disk is mounted, to the disk reproducing position where information reproduction or recording is performed from or in the disk mounted thereon.

As shown in FIGS. 2A and 2B, the chassis 2 has an installation space 21 formed inside thereof and the tray 4 is housed in the installation space 21 when it is located at the disk reproducing position. Further, the chassis 2 installs therein various components that form the disk drive 1-1. One of the components installed therein is a drive motor (not shown) that is connected to the tray 4 via a gear and moves the tray 4 from the disk mounting position to the disk reproducing position. There is also a main cam 22 being a drive element that is connected to the drive motor (not shown) via a gear, and moves in one direction or in a width direction of the disk drive 1-1 in this case, namely, a width direction (horizontal direction in FIG. 2A) in association with the loading/unloading operation of the disk (not shown) or with movement of the tray 4 from the disk mounting position to the disk reproducing position. The main cam 22 is supported so as to be movable with respect to the chassis 2 in the width direction by using a sliding groove 21a formed in the chassis 2 and a sliding pin 22a formed in the main cam

There is also a traverse mechanism 23 (dashed line in FIG. 2A). The traverse mechanism 23 installs therein units including a disk clamping unit such as a turntable that clamps the disk, a disk rotating unit such as a disk rotating motor that rotates the disk clamped by the turntable, and a reproducing/recording unit such as a pickup that reads recorded information from the disk and writes information onto the disk. The traverse mechanism 23 is supported by a driven element 24 that goes up or down in association with movement of the main cam 22 in the width direction. Supporting shafts 24a and 24b formed in the driven element 24 are rotatably supported by bearings 21b and 21c formed in the chassis 2. In other words, the traverse mechanism 23 lifts up and down in association with movement of the main cam 22 that moves in the width direction by being associated with the loading/unloading operation of the disk by the tray 4.

Lifting up and down of the traverse mechanism 23 due to the main cam 22 is performed by a lift cam mechanism 25 provided between the main cam 22 and the driven element 24. The lift cam mechanism 25 includes a lift cam groove (not shown) formed in the main cam 22 and lift cam pins 25a and 25b formed in the driven element 24. A tray moving unit, the disk rotating unit, and the reproducing/recording unit, which are not shown, are controlled by a control unit (not shown).

Formed in the chassis 2 is a plurality of fixing holes 26a to 26d (four positions in FIG. 2A) that fix the upper case 3. Rotating shafts 27a and 27b are formed in both side faces of the chassis 2 near an end portion thereof in the unloading direction, and are inserted in sliding bearing holes 54a and 54b (explained later) respectively formed in the door element 5 to be supported. The rotating shafts 27a and 27b are formed in the thickness direction of the disk drive 1-1 or in the upper side higher than the central portion of the chassis 2 in the thickness direction thereof (vertical direction in FIG. 2B). Formed respectively in the rotating shafts 27a and 27b are locking bosses 27c and 27d which protrude and lock one ends of elastic elements 9a and 9b respectively (explained later). It is noted that a U-shaped chassis-side contact face 28a is formed in a substantially central portion of an end portion of the chassis 2 in the unloading direction. Sliding bosses 28b and 28c are also formed in the end portion of the chassis 2 in the unloading direction.

The upper case 3 is put on the chassis 2 to cover the installation space 21 (double-dashed line in FIGS. 2A and 2B). The upper case 3 has fixing holes 31a to 31d formed corresponding to the fixing holes 26a to 26d of the chassis 2. A case-side contact face 32 is formed in an end portion of the upper case 3 in the unloading direction. An opening-side contact face is formed of the case-side contact face 32 and the chassis-side contact face 28a. An opening portion S1 is formed in the disk drive body that includes the chassis 2 and the upper case 3, along the end portion in the unloading direction. The opening portion S1 is formed of the opening-side contact face i.e. the case-side contact face 32 and the chassis-side contact face 28a. The disk drive body that includes the chassis 2 and the upper case 3 is the one into or from which the disk is loaded or unloaded, and the loading/unloading operation of the disk by the tray 4 is performed through the opening portion S1.

The tray 4 moves from the disk mounting position (not shown) to the disk reproducing position (see FIG. 1A). The tray 4 is supported by a plurality of guide elements (not shown) formed in the chassis 2 so as to be movable from the disk mounting position to the disk reproducing position. The movement of the tray 4 is performed by the tray moving unit (not shown). More specifically, when the disk is loaded into the disk drive 1-1, the tray moving unit (not shown) moves the tray 4 from the disk mounting position to the disk reproducing position, and moves the tray 4 from the disk reproducing position to the disk mounting position when the disk is unloaded from the disk drive 1-1.

As shown in FIGS. 3A and 3B, the tray 4 includes amount portion 41 formed in a substantially central portion thereof. The mount portion 41 has an area so that a cartridge (not shown) containing therein the disk can be mounted thereon. Formed in the mount portion 41 are mounting-use concave portions 41a and 41b to mount thereon a disk not contained in the cartridge. It is noted that a disk with a large diameter (disk of 12 centimeters) can be mounted on the mounting-use concave portion 41a, and that a disk with a small diameter (disk of, for example, 8 centimeters) can be mounted on the mounting-use concave portion 41b. Reference numeral 41c indicates a positioning pin inserted in a positioning hole of the cartridge (not shown) when the cartridge (not shown) is mounted on the mount portion 41. Reference numeral 42 indicates a sliding element that opens a shutter of the cartridge (not shown) and exposes the disk contained in the cartridge to the outside of the cartridge. The sliding element 42 slides in a direction orthogonal to the loading/unloading direction of the tray 4, or in the width direction in this case, in association with the loading/unloading operation of the disk by the tray 4.

As shown in FIGS. 4A to 4D, the door element 5 performs opening and closing of the opening portion S1 formed in the disk drive body i.e. in the chassis 2 and the upper case 3. That is, the door element 5 opens and blocks the opening portion S1. The door element 5 includes a front-face portion 51 and arm portions 52 and 53. The front-face portion 51 is a rectangle, and the arm portions 52 and 53 are formed at both ends of the rectangle in its longitudinal direction or in its width direction, by being protruded toward the loading direction. Formed in a back side 51a of the front-face portion 51 or in the door-side contact face of the door element 5 are moving-side cam grooves 63 and 64 of a moving-side cam mechanism 6-1. A surface 51b is formed in parallel with the opening/closing direction in which the door element 5 is movably supported, or formed along a circumference around the rotating shafts 27a and 27b in this case.

Formed in the back side 51a of the front-face portion 51 are sliding grooves 56a and 56b which face the corresponding sliding bosses 28b and 28c of the chassis 2 respectively when the door element 5 is fixed to the chassis 2. The sliding grooves 56a and 56b are formed from the back side 51a toward the surface 51b of the front-face portion 51, or formed so as to be extended in the thickness direction. A height of the sliding bosses 28b and 28c or a length thereof in the unloading direction are set to a length so that the sliding bosses 28b and 28c are not disengaged from the sliding grooves 56a and 56b even if the door element 5 fixed to the chassis 2 moves. The width of the sliding bosses 28b and 28c in the width direction is set to slightly narrower than the width of the sliding grooves 56a and 56b in the width direction. Therefore, when the sliding bosses 28b and 28c are inserted in the sliding grooves 56a and 56b respectively upon fixing of the door element 5 to the chassis 2, the movement of the door element 5 with respect to the chassis 2 (disk drive body) in the width direction is restricted. Thus, a stable opening/closing operation of the door element 5 can be performed. A length of the sliding bosses 28b and 28c in the loading/unloading direction is preferably set to a length almost the same as that of moving-side cam pins 61 and 62 (explained later) of the moving-side cam mechanism 6-1 in the loading/unloading direction. Consequently, a depth of the sliding grooves 56a and 56b can be set to a depth almost the same as that of the moving-side cam grooves 63 and 64 (explained later) of the moving-side cam mechanism 6-1 (explained later). With this feature, the length of the door element 5 in the loading/unloading direction can be prevented from being increased.

The sliding bearing holes 54a and 54b are formed near end portions of the arm portions 52 and 53 in the loading direction side, respectively. The width of the sliding bearing holes 54a and 54b in the thickness direction is set to slightly wider than the diameter of the rotating shafts 27a and 27b of the chassis 2, and the length thereof in the loading/unloading direction is set to longer than the diameter of the rotating shafts 27a and 27b of the chassis 2 (e.g., about 1.5 times the diameter of the rotating shafts 27a and 27b). More specifically, if the rotating shafts 27a and 27b of the chassis 2 are inserted in the sliding bearing holes 54a and 54b of the door element 5 respectively to fix the door element 5 to the chassis 2, the door element 5 is movably supported in the loading/unloading direction with respect to the opening portion S1 or, in this case, for only a distance obtained by subtracting the diameter of the rotating shafts 27a and 27b from the length of the sliding bearing holes 54a and 54b in the loading/unloading direction. Furthermore, the door element 5 is movably supported in the opening/closing direction of opening or closing of the opening portion S1, or in the rotating direction around the rotating shafts 27a and 27b of the chassis 2 in this case. Locking bosses 55a and 55b are formed in the arm elements 52 and 53 respectively by protruding in the width direction, the locking bosses 55a and 55b locking the other ends of the elastic elements 9a and 9b (explained later) respectively.

The moving-side cam mechanism 6-1 is a door-element moving unit, and includes the moving-side cam pins 61 and 62 and the moving-side cam grooves 63 and 64 (see FIG. 1B). The moving-side cam pins 61 and 62 and the moving-side cam grooves 63 and 64 are separately formed in the main cam 22 being the drive element and in the door element 5, respectively. In this case, the moving-side cam pins 61 and 62 are formed in the main cam 22, and the moving-side cam grooves 63 and 64 are formed in the door element 5. As shown in FIG. 2A, the moving-side cam pins 61 and 62 are formed on the surface of the main cam 22 facing the back side 51a of the front-face portion 51 by protruding in the unloading direction so that when the door element 5 is fixed to the chassis 2, the moving-side cam pins 61 and 62 face the moving-side cam grooves 63 and 64 and are inserted thereinto respectively. That is, the moving-side cam pins 61 and 62 reciprocate within the moving-side cam grooves 63 and 64 respectively according to movement of the main cam 22 being the drive element in the width direction.

As shown in FIG. 4D, the moving-side cam grooves 63 and 64 are formed from the back side 51a toward the surface 51b of the front-face portion 51. The moving-side cam grooves 63 and 64 include horizontal regions at closed state 63a and 64a, step regions 63b and 64b, slope regions 63c and 64c, and horizontal regions at open state 63d and 64d which are formed adjacent to each other in this order from one end toward the other end of the grooves respectively (from the right side to the left side in FIG. 4B). The horizontal regions at closed state 63a and 64a are located at one ends of the moving-side cam grooves 63 and 64 respectively and are formed in parallel with the width direction. The step regions 63b and 64b are formed in parallel with the width direction. A depth D2 of the step regions 63b and 64b from the back side 51a of the front-face portion 51 is set to shallower than a depth D1 from the backside 51a of the front-face portion 51 in the horizontal regions at open state 63d and 64d, the slope regions 63c and 64c, and the horizontal regions at closed state 63a and 64a. That is, in the step regions 63b and 64b, each opening face of the moving-side cam grooves 63 and 64 or the depth from the back side 51a of the front-face portion 51 is formed differently from the other regions. The slope regions 63c and 64c are formed in the moving direction of the main cam 22 being the drive element or formed at a slope with respect to the width direction. The horizontal regions at open state 63d and 64d are located at the other end of the moving-side cam grooves 63 and 64 respectively and are formed in parallel with the width direction.

The control-side cam mechanism 7 is a movement control unit that controls movement of the door element 5 in the direction toward the opening portion S1 when the door element 5 moves in the opening/closing direction, and includes control-side cam pins 71 and 72 and control-side cam grooves 73 and 74 (see FIG. 1C). The control-side cam pins 71 and 72 and the control-side cam grooves 73 and 74 are separately formed in the chassis 2 (disk drive body) and in the door element 5 respectively. In this case, the control-side cam pins 71 and 72 are formed in the chassis 2, and the control-side cam grooves 73 and 74 are formed in the door element 5. As shown in FIG. 2A, the control-side cam pins 71 and 72 are formed on both sides of the chassis 2 facing the arm portions 52 and 53 of the door element 5 by protruding in the width direction so that the control-side cam pins 71 and 72 face the control-side cam grooves 73 and 74 and are inserted therein respectively when the door element 5 is fixed to the chassis 2. The control-side cam pins 71 and 72 reciprocate within the control-side cam grooves 73 and 74 respectively, with the movement of the door element 5 by the moving-side cam mechanism 6-1.

As shown in FIG. 4C, the control-side cam grooves 73 and 74 are formed by penetrating both faces of each of the arm portions 52 and 53. The control-side cam grooves 73 and 74 are formed of loading/unloading-directional regions 73a and 74a and opening/closing-directional regions 73b and 74b, respectively. The loading/unloading-directional regions 73a and 74a are formed in parallel with the loading/unloading direction. The loading/unloading-directional regions 73a and 74a are adjacent to the opening/closing-directional regions 73b and 74b respectively, and one ends of the loading/unloading-directional regions 73a and 74a or ends thereof in the loading direction in this case (right side in this figure) communicate with one ends of the opening/closing-directional regions 73b and 74b or with ends thereof in the opening direction in this case (lower side in this figure) respectively. The opening/closing-directional regions 73b and 74b are formed in parallel with the opening/closing direction in which the door element 5 is movably supported, or formed along the circumference around the rotating shafts 27a and 27b in this case.

How to assemble the disk drive 1-1 is explained below. At first, the tray 4 is supported by a plurality of guide elements (not shown) of the chassis 2 so as to be movable in the loading/unloading direction. Next, the fixing holes 31a to 31d of the upper case 3 are positioned against the fixing holes 26a to 26d of the chassis 2 respectively in a state where the tray 4 is supported by the chassis 2, and the upper case 3 is fixed to the chassis 2 by screwing fixing elements such as screws 8a to 8d into the fixing holes 26a to 26d respectively through the fixing holes 31a to 31d. The rotating shafts 27a and 27b of the chassis 2 are inserted in the sliding bearing holes 54a and 54b of the door element 5 respectively in a state where the tray 4 is located at the disk reproducing position, and the door element 5 is thereby fixed to the chassis 2 (disk drive body).

The elastic element 9a is locked between the locking boss 27c of the chassis 2 and the locking boss 55a of the door element 5, and the elastic element 9b is locked between the locking boss 27d of the chassis 2 and the locking boss 55b of the door element 5. The elastic elements 9a and 9b bias the door element 5 in a direction toward the opening portion S1 irrespective of the position of the door element 5 with respect to the opening portion S1. In other words, biasing force in the direction toward the opening portion S1 is always applied to the door element 5.

As shown in FIGS. 1A to 1C, when the disk drive 1-1 is assembled, the moving-side cam pins 61 and 62 of the moving-side cam mechanism 6-1 are inserted in the moving-side cam grooves 63 and 64 so as to be slidable within the moving-side cam grooves 63 and 64 respectively. The control-side cam pins 71 and 72 of the control-side cam mechanism 7 are also inserted in the control-side cam grooves 73 and 74 so as to be slidable within the control-side cam grooves 73 and 74 respectively. Furthermore, the sliding bosses 28b and 28c are inserted in the sliding grooves 56a and 56b so as to be slidable within the sliding grooves 56a and 56b respectively.

The operation of the disk drive 1-1 according to Example 1 is explained below. The case of unloading the disk by the tray 4 is explained first. When the disk is to be unloaded by the tray 4, as shown in FIGS. 1A to 1C, the tray 4 is located at the disk reproducing position. At this time, the main cam 22 is located at an end in the other direction of the width direction i.e. in a direction opposite to a direction of arrow B in the figure (see FIG. 2B). Therefore, in the moving-side cam mechanism 6-1 as shown in FIG. 1C, the moving-side cam pins 61 and 62 are located in the horizontal regions at closed state 63a and 64a of the moving-side cam grooves 63 and 64 respectively. A depth D1 of the horizontal regions at closed state 63a and 64a is deeper than a depth D2 of the step regions 63b and 64b, and thus the door element 5 blocks the opening portion S1. More specifically, the back side 51a which is the door-side contact face of the door element 5 comes into contact with the opening-side contact face or with the chassis-side contact face 28a and the case-side contact face 32. At the same time, in the control-side cam mechanism 7, the control-side cam pins 71 and 72 are located in the loading/unloading-directional regions 73a and 74a of the control-side cam grooves 73 and 74 respectively. This means that the movement of the door element 5 in the direction toward the opening portion S1 is not restricted by the control-side cam mechanism 7.

Next, the tray moving unit (not shown) is driven from the state where the tray 4 is located at the disk reproducing position. Consequently, the tray 4 starts moving from the disk reproducing position toward the unloading direction. At this time, the main cam 22 starts moving in one direction of the width direction i.e. in the direction of the arrow B in the figure by the tray moving unit. The traverse mechanism 23 starts going up when the main cam 22 starts moving in the one direction of the width direction. At the same time, in the moving-side cam mechanism 6-1, the moving-side cam pins 61 and 62 slide from the horizontal regions at closed state 63a and 64a to the step regions 63 band 64b of the moving-side cam grooves 63 and 64 respectively. Because the depth D2 of the step regions 63b and 64b is shallower than the depth D1 of the other regions, as shown in FIG. 5A, the door element 5 moves in the unloading direction against the biasing force which is biased by the elastic elements 9a and 9b in the direction toward the opening portion S1 and is applied to the door element 5. More specifically, the back side 51a which is the door-side contact face of the door element 5 separates from the chassis-side contact face 28a and the case-side contact face 32, and the door element 5 thereby separates from the opening portion S1. At the same time, in the control-side cam mechanism 7, the control-side cam pins 71 and 72 are located at the one ends of the loading/unloading-directional regions 73a and 74a of the control-side cam grooves 73 and 74 respectively. This means that the movement of the door element 5 in the direction toward the opening portion S1 is not restricted by the control-side cam mechanism 7.

Next, the tray moving unit (not shown) is further driven after the tray 4 starts moving in the unloading direction. Consequently, the main cam 22 further moves in the one direction of the width direction by the tray moving unit. The traverse mechanism 23 further goes up when the main cam 22 further moves in the one direction of the width direction. At the same time, in the moving-side cam mechanism 6-1, the moving-side cam pins 61 and 62 slide from the step regions 63b and 64b to the slope regions 63c and 64c of the moving-side cam grooves 63 and 64 respectively. The slope regions 63c and 64c slope with respect to the moving direction of the main cam 22 which is the drive element or with respect to the width direction, differently from the other regions. Thus, the door element 5 moves, as shown in FIG. 5A, in one direction of the rotating directions around the rotating shafts 27a and 27b, or in the opening direction of the opening/closing direction with respect to the opening portion S1. With the movement, as shown in FIG. 5B, the door element 5 opens the blocked opening portion S1. At the same time, in the control-side cam mechanism 7, the control-side cam pins 71 and 72 are located in the opening/closing-directional regions 73b and 74b of the control-side cam grooves 73 and 74 respectively. This means that the movement of the door element 5 in the direction toward the opening portion S1 is restricted by the control-side cam mechanism 7 upon movement thereof in the opening/closing direction. Therefore, the door element 5 can move in the opening/closing direction of the door element 5 while the door element 5 is kept away from the opening portion S1 by the control-side cam mechanism 7 being the movement control unit when moving in the opening/closing direction. Accordingly, the door element 5 can be prevented from contacting the opening portion S1 and other elements of the chassis 2 (disk drive body). Moreover, the opening/closing-directional regions 73b and 74b, through which the control-side cam pins 71 and 72 of the control-side cam mechanism 7 pass upon movement of the door element 5 in the opening/closing direction, are formed along the opening/closing direction of the door element 5. Thus, the state where the door element 5 is separated from the opening portion S1 upon movement of the door element 5 in the opening/closing direction can be easily maintained not by the moving-side cam mechanism 6-1 but by the control-side cam mechanism 7.

Next, the tray moving unit (not shown) is further driven, and the tray 4 thereby moves from the disk reproducing position to the disk mounting position through the opened opening portion S1. At this time, the main cam 22 is located at the end in one direction of the width direction by the tray moving unit. Consequently, in the moving-side cam mechanism 6-1, the moving-side cam pins 61 and 62 slide from the slope regions 63c and 64c to the horizontal regions at open state 63d and 64d of the moving-side cam grooves 63 and 64 respectively. Further, in the control-side cam mechanism 7, the control-side cam pins 71 and 72 are kept positioned in the opening/closing-directional regions 73b and 74b of the control-side cam grooves 73 and 74 respectively. This means that the moving-side cam mechanism 6-1 and the control-side cam mechanism 7 cause the door element 5 to maintain the state where the opening portion S2 is opened.

The case where the disk is loaded by the tray 4 is explained next. At first, the tray 4 is located at the disk mounting position, and the tray moving unit (not shown) is driven from the opening state of the opening portion S1 by the door element 5. The driving direction of the tray moving unit is a reverse direction to the driving direction when the disk is unloaded by the tray 4. Consequently, the tray 4 starts moving from the disk mounting position toward the loading direction. At this time, the main cam 22 starts moving in the other direction of the width direction by the tray moving unit. The traverse mechanism 23 starts going down when the main cam 22 starts moving in the other direction of the width direction. At the same time, in the moving-side cam mechanism 6-1, the moving-side cam pins 61 and 62 slide from the horizontal regions at open state 63d and 64d to the slope regions 63c and 64c of the moving-side cam grooves 63 and 64 respectively. And the door element 5 starts moving, as shown in FIG. 5B, in the other direction of the rotating directions around the rotating shafts 27a and 27b, or in the closing direction of the opening/closing direction with respect to the opening portion S1. Further, in the control-side cam mechanism 7, the control-side cam pins 71 and 72 are kept positioned in the opening/closing-directional regions 73b and 74b of the control-side cam grooves 73 and 74 respectively. This means that the control-side cam mechanism 7 maintains the state where the movement of the door element 5 in the direction toward the opening portion S1 is restricted.

Next, the tray moving unit (not shown) is further driven after the tray 4 starts moving in the loading direction. Consequently, the main cam 22 further moves in the other direction of the width direction by the tray moving unit. The traverse mechanism 23 further goes down when the main cam 22 further moves in the other direction of the width direction. At the same time, in the moving-side cam mechanism 6-1, the moving-side cam pins 61 and 62 slide from the slope regions 63c and 64c to the step regions 63b and 64b of the moving-side cam grooves 63 and 64 respectively. Further, in the control-side cam mechanism 7, the control-side cam pins 71 and 72 are located at the one ends of the loading/unloading-directional regions 73a and 74a of the control-side cam grooves 73 and 74 respectively. This means that the movement of the door element 5 in the direction toward the opening portion S1 is not restricted by the control-side cam mechanism 7. Thus, the door element 5 moves up to the position facing the opening portion S1, where the back side 51a which is the door-side contact face of the door element 5 faces the chassis-side contact face 28a and the case-side contact face 32.

Next, by further driving the tray moving unit (not shown), the tray 4 moves from the disk mounting position to the disk reproducing position through the opened opening portion S1. At this time, the main cam 22 is located at the end in the other direction of the width direction by the tray moving unit. Consequently, in the moving-side cam mechanism 6-1, the moving-side cam pins 61 and 62 slide from the step regions 63b and 64b to the horizontal regions at closed state 63a and 64a of the moving-side cam grooves 63 and 64 respectively. Further, in the control-side cam mechanism 7, the control-side cam pins 71 and 72 are located in the loading/unloading-directional regions 73a and 74a of the control-side cam grooves 73 and 74 respectively. Therefore, as shown in FIG. 5A, the door element 5 moves in the loading direction by the biasing force which is biased in the direction toward the opening portion S1 by the elastic elements 9a and 9b and is applied to the door element 5. As shown in FIG. 1C, the back side 51a being the door-side contact face of the door element 5 comes into contact with the chassis-side contact face 28a and the case-side contact face 32, and the door element 5 thereby blocks the opening portion S1.

As explained above, in the disk drive 1-1 according to Example 1, when the disk is unloaded by the tray 4, the door element 5 moves in the unloading direction of the loading/unloading direction with respect to the opening portion S1, and the door element 5 thereby separates from the opening portion S1 blocked by contacting the back side 51a with the chassis-side contact face 28a and the case-side contact face 32. And the door element 5 moves in the opening direction of the opening/closing direction to thereby open the opening portion. On the other hand, when the disk is loaded by the tray 4, the door element 5 moves in the closing direction of the opening/closing direction, and the back side 51a thereby faces the chassis-side contact face 28a and the case-side contact face 32, and thus the door element 5 faces the opening portion S1. The door element 5 moves in the loading direction of the loading/unloading direction with respect to the opening portion S1, the back side 51a thereby comes into contact with the chassis-side contact face 28a and the case-side contact face 32, and thus the door element 5 blocks the opening portion S1. Therefore, the door element 5 maintains its state of being in contact with the opening portion S1 at any time other than the time of loading or unloading the disk by the tray 4. Thus, the dust prevention for the inner side of the disk drive body including the chassis 2 and the upper case 3 can be reliably achieved.

In the disk drive 1-1 according to Example 1, the rotating shafts 27a and 27b which are the centers when the door element 5 moves in the opening/closing direction are formed in the upper side higher than the central portion in the thickness direction of the chassis 2, and the surface 51b of the door element 5 is formed along the circumference around the rotating shafts 27a and 27b. Thus, the region where the door element 5 moves can be reduced, and the space allowing the door element 5 to be moved can be reduced.

In the disk drive 1-1 according to Example 1, the moving-side cam mechanism 6-1 provided between the main cam 22 being the drive element and the door element 5 allows the door element 5 to move, specifically, to move in the loading/unloading direction and in the opening/closing direction. Therefore, any new component is not needed to move the door element 5 in the two directions, and thus an increase in the number of components can be prevented. Moreover, the disk drive 1-1 can be minimized.

The disk drive 1-1 according to Example 1 does not allow the following movements such that the tray 4 moves in the unloading direction and thereby contacts the door element 5, and that this contact causes the door element 5 to move the opening direction. Thus, the biasing force of the elastic elements 9a and 9b can be prevented from becoming load on the loading/unloading operation of the tray 4.

The disk drive 1-1 according to Example 1 may include the fitting units between the back side 51a, which is the door-side contact face, and the chassis-side contact face 28a and the case-side contact face 32 which are opening-side contact faces as shown in FIG. 6A. It is noted that a position where the door element 5 faces the opening portion S1 shown in FIG. 6A (double-dashed line in this figure) is shown in such a manner that the position is separated farther from the opening portion S1 than an actual position. The fitting unit is a concave/convex portion which is provided in either the back side 51a, or the chassis-side contact face 28a and the case-side contact face 32. In this case, a convex portion 57 is formed in the backside 51a, and concave portions 28d and 33 are formed in the opening-side contact face i.e. in the chassis-side contact face 28a and the case-side contact face 32 respectively. It is noted that the concave portions 28d and 33 are formed so as to communicate with each other. The concave portions 28d and 33 are formed so as to surround the opening portion S1. The convex portion 57 is formed at a position facing the concave portions 28d and 33 when the door element 5 blocks the opening portion S1 (double-dashed line in this figure). Therefore, when the back side 51a comes into contact with the opening-side contact face 28a and the opening-side contact face 32 and blocks the opening portion S1, the convex portion 57 is inserted in the concave portions 28d and 33. Consequently, it is possible to further prevent dust from entering through a space between the door element 5 and the opening portion S1, and thus the dust prevention for the inner side of the disk drive body including the chassis 2 and the upper case 3 can be more reliably achieved.

As shown in FIG. 6B, the disk drive 1-1 according to Example 1 may include the cushion element 10 on either the back side 51a being the door-side contact face, or the chassis-side contact face 28a and the case-side contact face 32 being opening-side contact faces. It is noted that a position where the door element 5 faces the opening portion S1 as shown in FIG. 6B (double-dashed line in this figure) is shown in such a manner that the position is separated farther from the opening portion S1 than an actual position. In this case, the cushion element 10 such as rubber and foamed element is attached to the back side 51a. The cushion element 10 is ring-shaped, and is formed so as to surround the opening portion S1 when the door element 5 blocks the opening portion S1 (double-dashed line in this figure). Consequently, when the door element 5 faces the opening portion S1, moves in the loading direction with respect to the opening portion S1, and blocks the opening portion, the cushion element 10 attached to the back side 51a comes into contact with the opening-side contact face 28a and the opening-side contact face 32. In other words, the cushion element 10 contacts the door element 5 and the opening portion S1 to surround the opening portion S1. Therefore, it is possible to further prevent dust from entering through a space between the door element 5 and the opening portion S1, and thus dust prevention for the inner side of the disk drive body including the chassis 2 and the upper case 3 can be more reliably achieved.

As explained above, the disk drive 1-1 according to Example 1 includes the chassis 2 and the upper case 3 being the disk drive body in which the opening portion S1 is formed in the loading/unloading direction of the disk and into or from which the disk is loaded or unloaded through the opening portion S1, the door element 5 supported by the chassis 2 being the disk drive body so as to be movable in the loading/unloading direction with respect to the opening portion S1 and movable in the opening/closing direction of opening or closing the opening portion S1, and the moving-side cam mechanism 6-1 being the door-element moving unit that moves the door element 5, which blocks the opening portion S1, in the unloading direction of the loading/unloading direction and moves the door element 5, which is separated from the opening portion S1, in the opening direction of opening the opening portion S1 of the opening/closing direction, in association with the unloading operation of the disk. Thus, it is possible to reliably perform dust prevention for the disk drive 1-1.

### Example 2

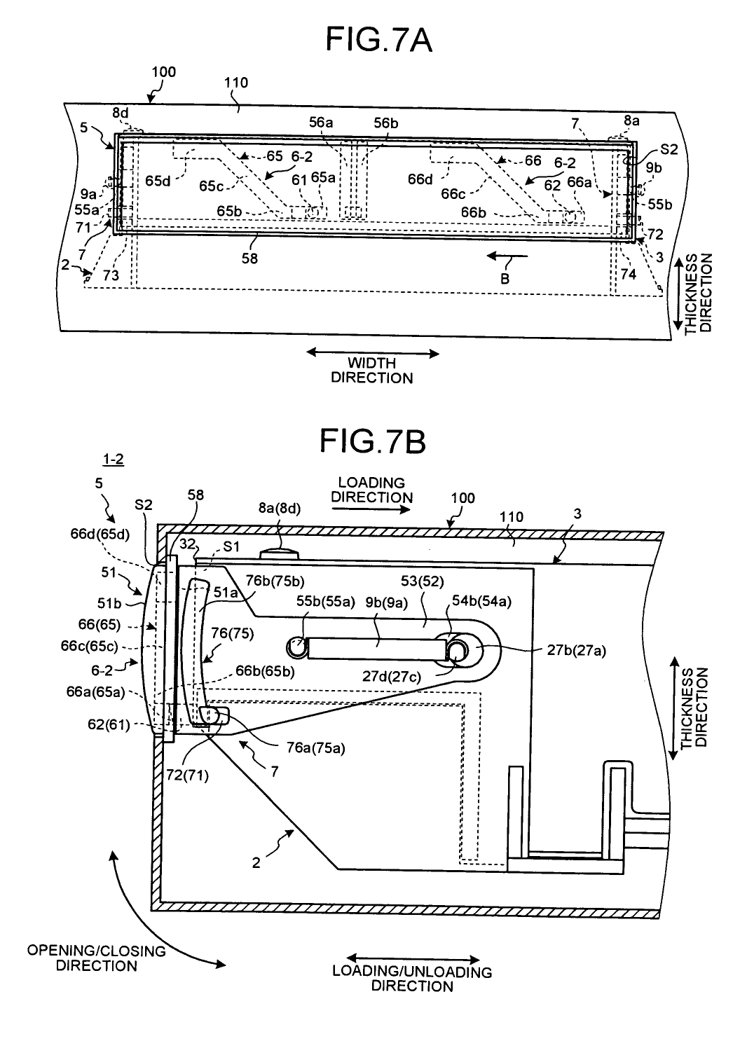

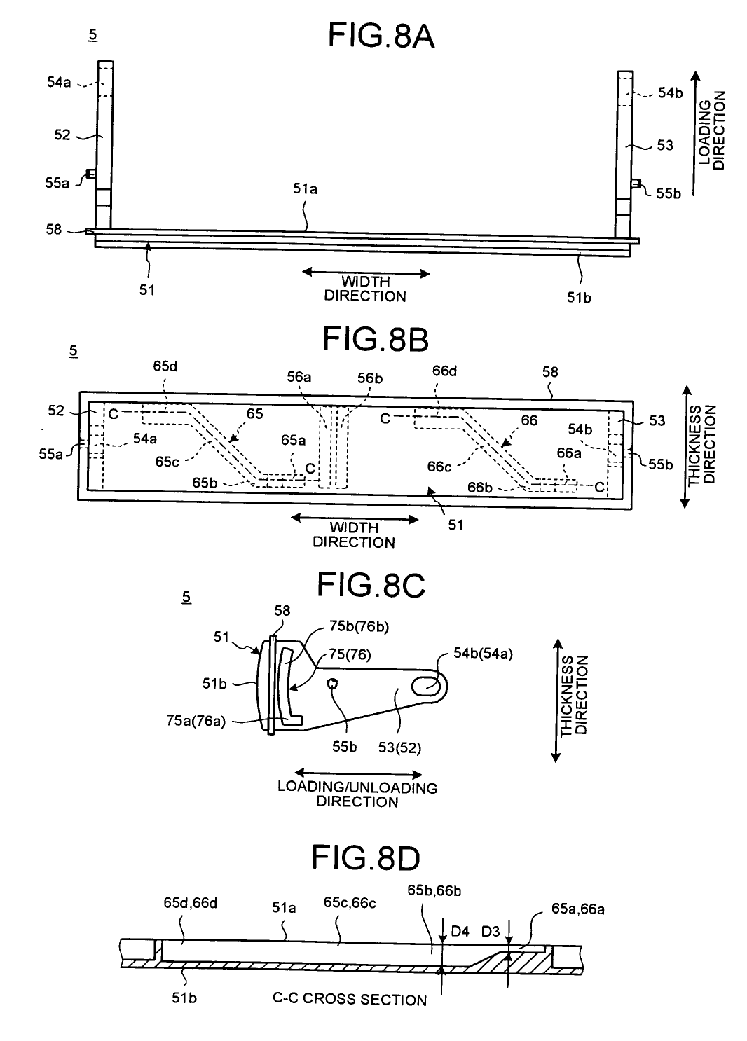

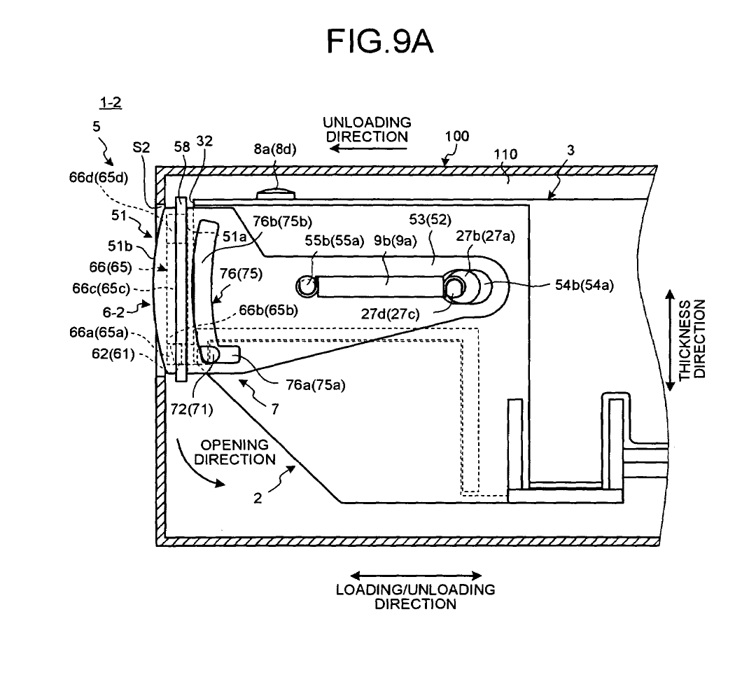

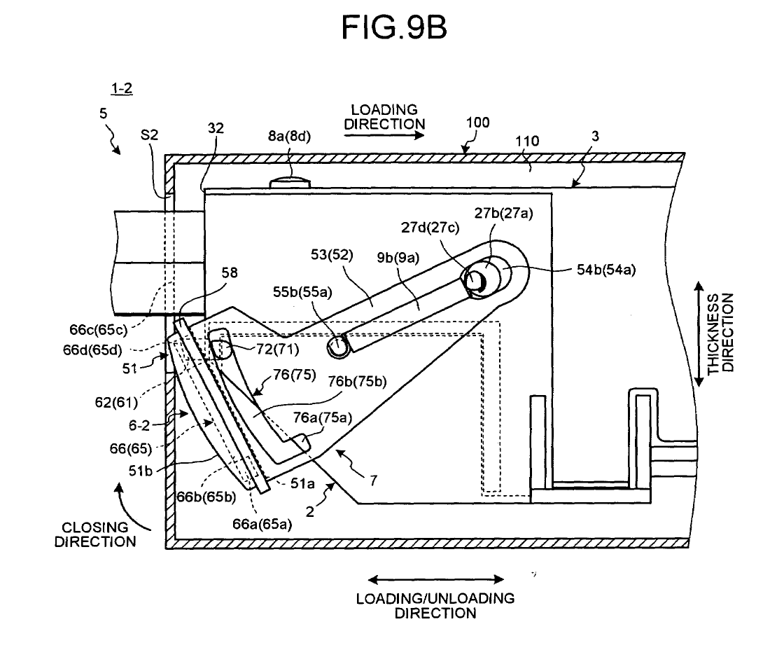

A disk drive 1-2 according to Example 2 is explained next. FIGS. 7A and 7B are schematics of a configuration example of the disk drive according to Example 2. FIGS. 8A to 8D are schematics of a configuration example of the door element 5. FIGS. 9A and 9B are schematics for explaining an operation of the disk drive according to Example 2. The disk drive 1-2 according to Example 2 as shown in FIGS. 7A and 7B is different from the disk drive 1-1 according to Example 1 as shown in FIGS. 1A to 1C in that the door element 5 blocks not the opening portion formed in the disk drive body but an opening portion S2 formed in an electronic device that houses therein the disk drive 1-2. Of the basic configuration of the disk drive 1-2 according to Example 2, the same portions as the basic configuration of the disk drive 1-1 according to Example 1 (portions indicated by the same reference numerals in FIGS. 1A to 5B and FIGS. 7A to 9B) are simplified or omitted in the following explanation.

As shown in FIGS. 7A and 7B, the disk drive 1-2 according to Example 2 is housed in an internal portion 110 of an electronic device 100 such as a personal computer, a DVD player, and a DVD recorder. Formed in the electronic device 100 is the opening portion S2 that penetrates an external portion and the internal portion 110. The disk drive 1-2 loads or unloads the disk thereinto or therefrom through the opening portion S2. The disk drive 1-2 is fixed to the electronic device 100 by fixing units (not shown) such as a screw.

As shown in FIGS. 8A to 8D, the door element 5 opens/closes the opening portion S2 of the electronic device 100, or opens the opening portion S2 and blocks the opening portion S2. A flange portion 58 is formed around a peripheral side face of the front-face portion 51 of the door element 5. The flange portion 58 is formed wider than the opening portion S2 of the electronic device 100. Of both faces of the flange portion 58 in the loading/unloading direction, a face on the unloading direction side (door-side contact face) comes into contact with an internal surface (opening-side contact face) of the electronic device 100 that forms therein the opening portion S2, and the door element 5 thereby blocks the opening portion S2. It is noted that, of the front-face portion 51, a portion on the unloading direction side from the flange portion 58 is formed narrower than the opening portion S2 of the electronic device 100. In other words, when the door element 5 blocks the opening portion S2, part of the front-face portion 51 of the door element 5 can be inserted in the opening portion S2. Therefore, it is possible to prevent deposition of dust in the opening portion S2 during blocking the opening portion S2 by the door element 5.

A moving-side cam mechanism 6-2 is a door-element moving unit, and includes the moving-side cam pins 61 and 62 and moving-side cam grooves 65 and 66 (see FIG. 7A). The moving-side cam pins 61 and 62 and the moving-side cam grooves 65 and 66 are separately formed in the main cam 22 which is the drive element and the door element 5 respectively. In this case, the moving-side cam pins 61 and 62 are formed in the main cam 22, and the moving-side cam grooves 65 and 66 are formed in the door element 5. The moving-side cam pins 61 and 62 reciprocate within the moving-side cam grooves 65 and 66 respectively by the movement of the main cam 22 being the drive element in the width direction.

As shown in FIG. 8D, the moving-side cam grooves 65 and 66 are formed from the back side 51a toward the surface 51b of the front-face portion 51. The moving-side cam grooves 65 and 66 include horizontal regions at closed state 65a and 66a, step regions 65b and 66b, slope regions 65c and 66c, and horizontal regions at open state 65d and 66d which are formed adjacent to each other in this order from one end toward the other end of the grooves respectively (right side to left side in FIG. 8B). The horizontal regions at closed state 65a and 66a are located at one ends of the moving-side cam grooves 65 and 66 respectively and are formed in parallel with the width direction. The step regions 65b and 66b are formed in parallel with the width direction. In the horizontal regions at open state 65d and 66d, the slope regions 65c and 66c, and the step regions 65b and 66b, a depth D4 from the back side 51a of the front-face portion 51 is set to deeper than a depth D3 from the back side 51a of the front-face portion 51 in the horizontal regions at closed state 65a and 66a. That is, in the horizontal regions at open state 65d and 66d, the slope regions 65c and 66c, and the step regions 65b and 66b, each opening face of the moving-side cam grooves 65 and 66 i.e. the depth from the back side 51a of the front-face portion 51 is formed differently from the other region. The slope regions 65c and 66c are formed in the moving direction of the main cam 22 being the drive element or formed at a slope with respect to the width direction. The horizontal regions at open state 65d and 66d are located at the other ends of the moving-side cam grooves 65 and 66 respectively, and formed in parallel with the width direction.

The control-side cam mechanism 7 is a movement control unit that controls movement of the door element 5 in the direction toward the opening portion S2 when the door element 5 moves in the opening/closing direction, and includes the control-side cam pins 71 and 72 and control-side cam grooves 75 and 76 (see FIG. 7B). The control-side cam pins 71 and 72 and the control-side cam grooves 75 and 76 are separately formed in the chassis 2 (disk drive body) and the door element 5 respectively. In this case, the control-side cam pins 71 and 72 are formed in the chassis 2, and the control-side cam grooves 75 and 76 are formed in the door element 5. The control-side cam pins 71 and 72 reciprocate within the control-side cam grooves 75 and 76 respectively, with the movement of the door element 5 by the moving-side cam mechanism 6-2.

As shown in FIG. 8C, the control-side cam grooves 75 and 76 are formed of loading/unloading-directional regions 75a and 76a and opening/closing-directional regions 75b and 76b respectively. The loading/unloading-directional regions 75a and 76a are formed in parallel with the loading/unloading direction. The loading/unloading-directional regions 75a and 76a are adjacent to the opening/closing-directional regions 75b and 76b respectively. The other ends of the loading/unloading-directional regions 75a and 76a or the ends (left side in the figure) in the unloading direction in this case communicate with the one ends of the opening/closing-directional regions 75b and 76b or with the ends (lower side in the figure) in the opening direction in this case, respectively.

The operation of the disk drive 1-2 according to Example 2 is explained below. The case of unloading the disk by the tray 4 is explained first. When the disk is to be unloaded by the tray 4, the tray 4 is located at the disk reproducing position, and the main cam 22 is located at an end in the other direction of the width direction (see FIG. 2B). Therefore, in the moving-side cam mechanism 6-2, as shown in FIGS. 7A and 7B, the moving-side cam pins 61 and 62 are located in the horizontal regions at closed state 65a and 66a of the moving-side cam grooves 65 and 66 respectively. The depth D3 of the horizontal regions at closed state 65a and 66a is shallower than the depth D4 of the step regions 65b and 66b, and thus the door element 5 blocks the opening portion S2. In other words, the flange portion 58 of the door element 5 is in contact with the internal surface of the electronic device 100. At the same time, in the control-side cam mechanism 7, the control-side cam pins 71 and 72 are located in the loading/unloading-directional regions 75a and 76a of the control-side cam grooves 75 and 76 respectively. This means that the movement of the door element 5 in the direction toward the opening portion S2 is not restricted by the control-side cam mechanism 7.

Next, the tray moving unit (not shown) is driven from the state where the tray 4 is located at the disk reproducing position. Consequently, the tray 4 starts moving from the disk reproducing position toward the unloading direction. At this time, the main cam 22 starts moving in one direction of the width direction by the tray moving unit. The traverse mechanism 23 starts going up when the main cam 22 starts moving in the one direction of the width direction. At the same time, in the moving-side cam mechanism 6-2, the moving-side cam pins 61 and 62 slide from the horizontal regions at closed state 65a and 66a to the step regions 65b and 66b of the moving-side cam grooves 65 and 66 respectively. As shown in FIG. 9A, because the depth D4 of the step regions 65b and 66b is deeper than the depth D3 of the other region, the door element 5 moves in the loading direction by the biasing force, applied to the door element 5, which is biased by the elastic elements 9a and 9b in the direction of separating from the opening portion S2. More specifically, the flange portion 58 of the door element 5 separates from the internal surface of the electronic device 100 and the door element 5 separates from the opening portion S2. At the same time, in the control-side cam mechanism 7, the control-side cam pins 71 and 72 are located in the other ends of the loading/unloading-directional regions 75a and 76a of the control-side cam grooves 75 and 76 respectively. This means that the movement of the door element 5 in the direction toward the opening portion S2 is not restricted by the control-side cam mechanism 7.

Next, the tray moving unit (not shown) is further driven after the tray 4 starts moving in the unloading direction. Consequently, the main cam 22 further moves in the one direction of the width direction by the tray moving unit. The traverse mechanism 23 further goes up when the main cam 22 further moves in the one direction of the width direction. At the same time, in the moving-side cam mechanism 6-2, the moving-side cam pins 61 and 62 slide from the step regions 65b and 66b to the slope regions 65c and 66c of the moving-side cam grooves 65 and 66 respectively. The slope regions 65c and 66c slope with respect to the moving direction of the main cam 22 which is the drive element or with respect to the width direction, differently from the other regions. Thus, the door element 5 moves, as shown in FIG. 9A, in one direction of the rotating directions around the rotating shafts 27a and 27b or in the opening direction of the opening/closing direction with respect to the opening portion S2. With this movement, as shown in FIG. 9B, the door element 5 opens the blocked opening portion S2. At the same time, in the control-side cam mechanism 7, the control-side cam pins 71 and 72 are located in the opening/closing-directional regions 75b and 76b of the control-side cam grooves 75 and 76 respectively. This means that the movement of the door element 5 in the direction toward the opening portion S2 is restricted by the control-side cam mechanism 7 upon movement thereof in the opening/closing direction. Therefore, the door element 5 can move in the opening/closing direction thereof while the door element 5 is kept away from the opening portion S2 by the control-side cam mechanism 7 being the movement control unit when moving in the opening/closing direction. Accordingly, it is possible to prevent the door element 5 from contacting the opening portion S2 and other elements of the chassis 2 (disk drive body). Moreover, the opening/closing-directional regions 75b and 76b, through which the control-side cam pins 71 and 72 of the control-side cam mechanism 7 pass upon movement of the door element 5 in the opening/closing direction, are formed along the opening/closing direction of the door element 5. Thus, the state where the door element 5 is separated from the opening portion S2 upon movement of the door element 5 in the opening/closing direction can be easily maintained not by the moving-side cam mechanism 6-2 but by the control-side cam mechanism 7.

Next, the tray moving unit (not shown) is further driven, and the tray 4 thereby moves from the disk reproducing position to the disk mounting position through the opened opening portion S2. At this time, the main cam 22 is located at the end in one direction of the width direction by the tray moving unit. Consequently, in the moving-side cam mechanism 6-2, the moving-side cam pins 61 and 62 slide from the slope regions 65c and 66c to the horizontal regions at open state 65d and 66d of the moving-side cam grooves 65 and 66 respectively. Further, in the control-side cam mechanism 7, the control-side cam pins 71 and 72 are kept positioned in the opening/closing-directional regions 75b and 76b of the control-side cam grooves 75 and 76 respectively. This means that the moving-side cam mechanism 6-2 and the control-side cam mechanism 7 cause the door element 5 to maintain the state where the opening portion S2 is opened.

The case where the disk is loaded by the tray 4 is explained next. At first, the tray 4 is located at the disk mounting position, and the tray moving unit (not shown) is driven from the state where the opening portion S2 is opened by the door element 5. The driving direction of the tray moving unit is a reverse direction to the driving direction when the disk is unloaded by the tray 4. Accordingly, the tray 4 starts moving from the disk mounting position toward the loading direction. At this time, the main cam 22 starts moving in the other direction of the width direction by the tray moving unit. The traverse mechanism 23 starts going down when the main cam 22 starts moving in the other direction of the width direction. At the same time, in the moving-side cam mechanism 6-2, the moving-side cam pins 61 and 62 slide from the horizontal regions at open state 65d and 66d to the slope regions 65c and 66c of the moving-side cam grooves 65 and 66 respectively. And the door element 5 starts moving, as shown in FIG. 9B, in other direction of the rotating directions around the rotating shafts 27a and 27b, or in the closing direction of the opening/closing direction with respect to the opening portion S2. Further, in the control-side cam mechanism 7, the control-side cam pins 71 and 72 are kept positioned in the opening/closing-directional regions 75b and 76b of the control-side cam grooves 73 and 74 respectively. This means that the control-side cam mechanism 7 maintains the state where the movement of the door element 5 in the direction toward the opening portion S2 is restricted.

Next, the tray moving unit (not shown) is further driven after the tray 4 starts moving in the loading direction. Consequently, the main cam 22 further moves in the other direction of the width direction by the tray moving unit. The traverse mechanism 23 further goes down when the main cam 22 further moves in the other direction of the width direction. At the same time, in the moving-side cam mechanism 6-2, the moving-side cam pins 61 and 62 slide from the slope regions 65c and 66c to the step regions 65b and 66b of the moving-side cam grooves 65 and 66 respectively. Further, in the control-side cam mechanism 7, the control-side cam pins 71 and 72 are located at the other ends of the loading/unloading-directional regions 75a and 76a of the control-side cam grooves 75 and 76 respectively. This means that the movement of the door element 5 in the direction toward the opening portion S2 is not restricted by the control-side cam mechanism 7. Thus, the door element 5 moves up to the position facing the opening portion S2, where the flange portion 58 of the door element 5 faces the internal surface of the electronic device 100.

Next, by further driving the tray moving unit (not shown), the tray 4 moves from the disk mounting position to the disk reproducing position through the opened opening portion S2. At this time, the main cam 22 is located at the end in the other direction of the width direction by the tray moving unit. Consequently, in the moving-side cam mechanism 6-2, the moving-side cam pins 61 and 62 slide from the step regions 65b and 66b to the horizontal regions at closed state 65a and 66a of the moving-side cam grooves 65 and 66 respectively. Further, in the control-side cam mechanism 7, the control-side cam pins 71 and 72 are located in the loading/unloading-directional regions 75a and 76a of the control-side cam grooves 75 and 76 respectively. Therefore, as shown in FIG. 9A, the door element 5 moves in the loading direction against the biasing force, applied to the door element 5, which is biased by the elastic elements 9a and 9b in the direction of separating from the opening portion S2. As shown in FIG. 7B, the flange portion 58 of the door element 5 comes into contact with the internal surface of the electronic device 100, and the door element 5 thereby blocks the opening portion S2.

As explained above, in the disk drive 1-2 according to Example 2, when the disk is unloaded by the tray 4, the door element 5 moves in the loading direction of the loading/unloading direction with respect to the opening portion S2, which is formed in the electronic device 100 whose internal surface is contacted with the flange portion 58, to separate from the opening portion S2 which is blocked by the door element 5 in such a manner that the flange portion 58 is in contact with the internal surface. Thereafter, the door element 5 moves in the opening direction of the opening/closing direction to open the opening portion S2. On the other hand, when the disk is loaded by the tray 4, the door element 5 moves in the closing direction of the opening/closing direction, the flange portion 58 thereby faces the internal surface and the door element 5 faces the opening portion S2. Thereafter, the door element 5 moves in the unloading direction of the loading/unloading direction with respect to the opening portion S2, and the flange portion 58 thereby comes into contact with the internal surface, and the door element 5 blocks the opening portion S2. Consequently, the door element 5 maintains its state of being in contact with the opening portion S2 at any time other than the time of loading or unloading the disk by the tray 4. Thus, it is possible to reliably achieve dust prevention for the inner side of not only the disk drive 1-2 but also of the electronic device 100 that houses therein the disk drive 1-2.

Similarly to Example 1, the disk drive 1-2 according to Example 2 allows the space for moving the door element 5 to be reduced. Moreover, a new component is not needed to move the door element 5 in the two directions, and this allows an increase in the number of components to be prevented. Further, the disk drive 1-2 can be minimized. Moreover, it is possible to prevent the biasing force of the elastic elements 9a and 9b from becoming load on the loading/unloading operation of the tray 4.

Similarly to Example 1, also in the disk drive 1-2 according to Example 2, the fitting units may be provided between the face of the flange portion 58 being the door-side contact face on the unloading direction side and the internal surface of the electronic device 100 being the opening-side contact face. Moreover, the cushion element may be provided between the face of the flange portion 58 being the door-side contact face on the unloading direction side and the internal surface of the electronic device 100 being the opening-side contact face.

As explained above, the disk drive 1-2 according to Example 2 includes the chassis 2 and the upper case 3 being the disk drive body into or from which the disk is loaded or unloaded, the door element 5 supported by the chassis 2 being the disk drive body so as to be movable in the loading/unloading direction with respect to the opening portion S2 formed in the electronic device 100 that houses therein the disk drive body and movable in the opening/closing direction of opening or closing the opening portion S2, and the moving-side cam mechanism 6-2 being the door-element moving unit that moves the door element 5, which blocks the opening portion S2, in the loading direction of the loading/unloading direction and moves the door element 5, which is separated from the opening portion S2, in the direction of opening the opening portion S2 of the opening/closing direction, in association with the unloading operation of the disk. Thus, it is possible to reliably achieve dust prevention for not only the disk drive 1-2 but also the electronic device 100.

According to Example 1 and Example 2, the control-side cam mechanism 7 being the movement control unit is used to control the movement of the door element 5 in the direction toward the opening portion S2 upon movement of the door element 5 in the opening/closing direction, however, the present invention is not limited thereby. For example, the moving-side cam mechanisms 6-1 and 6-2 may be used as the movement control unit. In this case, the depths D1 and D3 of the slope regions 63c, 64c, 65c, and 66c and of the horizontal regions at open state 63d, 64d, 65d, and 66d of the moving-side cam grooves 63 to 66 respectively are set the same as the depths D2 and D4 of the step regions 63b, 64b, 65b, and 66b respectively. Thus, when the moving-side cam pins 61 and 62 slide along the slope regions 63c, 64c, 65c, and 66c and the horizontal regions at open state 63d, 64d, 65d, and 66d, the door element 5 can be moved in the opening/closing direction while the door element 5 is kept away from the opening portions S1 and S2.

### INDUSTRIAL APPLICABILITY

As explained above, the disk drive according to the present invention is useful for any disk drive that includes the door element opening/closing in association with the loading/unloading operation of the disk, and is particularly suitable for reliable dust prevention.

1-6. (canceled)

7. A disk drive comprising:
a disk drive body in which an opening portion is formed in a loading/unloading direction of a disk, and into or from which the disk is loaded or unloaded through the opening portion;
a door element supported by the disk drive body so as to be movable in the loading/unloading direction with respect to the opening portion and movable in an opening/closing direction of opening or closing the opening portion;
a door-element moving unit that moves the door element, which blocks the opening portion, in the unloading direction of the loading/unloading direction and moves the door element, which is separated from the opening portion, in a direction of opening the opening portion of the opening/closing direction, in association with an unloading operation of the disk; and
a drive element that is supported in the disk drive body so as to be movable in one direction, and moves in association with the loading/unloading operation of the disk, wherein
the door-element moving unit includes a moving-side cam mechanism formed of at least moving-side cam pins and moving-side cam grooves which are separately formed in the drive element and the door element respectively,
the moving-side cam pins reciprocate within the moving-side cam grooves respectively by movement of the drive element, and
the moving-side cam grooves include at least
step regions of which a depth from opening faces of the moving-side cam grooves is formed differently from a depth of other regions, and through which the moving-side cam pins pass to allow the door element in contact with the opening portion to move in the loading/unloading direction, and
slope regions that are formed so as to be adjacent to the step regions and slope with respect to a moving direction of the drive element, and through which the moving-side cam pins pass to allow the door element separated from the opening portion to move in the opening/closing direction.

8. The disk drive according to claim 7, wherein
the door-element moving unit further includes a movement control unit that controls movement of the door element in a direction toward the opening portion when the door element moves in the opening/closing direction.

9. The disk drive according to claim 7, wherein fitting units are provided between a door-side contact face of the door element that blocks the opening portion and opening-side contact faces that face the door-side contact face when the opening portion is blocked, and one of the fitting units is fitted in the other to surround the opening portion when the door-side contact face comes into contact with the opening-side contact faces.

10. The disk drive according to claim 7, wherein a cushion element is provided in either one of a door-side contact face of the door element that blocks the opening portion and opening-side contact faces that face the door-side contact face when the opening portion is blocked, the cushion element surrounding the opening portion when the cushion element comes into contact with the door-side contact face and the opening-side contact faces.

11. A disk drive comprising:
a disk drive body into or from which a disk is loaded or unloaded;
a door element supported by the disk drive body so as to be movable in a loading/unloading direction with respect to an opening portion formed in an electronic device that houses therein the disk drive body and movable in an opening/closing direction of opening or closing the opening portion;
a door-element moving unit that moves the door element, which blocks the opening portion, in the loading direction of the loading/unloading direction and moves the door element, which is separated from the opening portion, in a direction of opening the opening portion of the opening/closing direction, in association with an unloading operation of the disk; and
a drive element that is supported in the disk drive body so as to be movable in one direction, and moves in association with the loading/unloading operation of the disk, wherein
the door-element moving unit includes a moving-side cam mechanism formed of at least moving-side cam pins and moving-side cam grooves which are separately formed in the drive element and the door element respectively,
the moving-side cam pins reciprocate within the moving-side cam grooves respectively by movement of the drive element, and
the moving-side cam grooves include at least
step regions of which a depth from opening faces of the moving-side cam grooves is formed differently from a depth of other regions, and through which the moving-side cam pins pass to allow the door element in contact with the opening portion to move in the loading/unloading direction, and
slope regions that are formed so as to be adjacent to the step regions and slope with respect to a moving direction of the drive element, and through which the moving-side cam pins pass to allow the door element separated from the opening portion to move in the opening/closing direction.

12. The disk drive according to claim 11, wherein
the door-element moving unit further includes a movement control unit that controls movement of the door element in a direction toward the opening portion when the door element moves in the opening/closing direction.

13. The disk drive according to claim 11, wherein fitting units are provided between a door-side contact face of the door element that blocks the opening portion and opening-side contact faces that face the door-side contact face when the opening portion is blocked, and one of the fitting units is fitted in the other to surround the opening portion when the door-side contact face comes into contact with the opening-side contact faces.

14. The disk drive according to claim 11, wherein a cushion element is provided in either one of a door-side contact face of the door element that blocks the opening portion and opening-side contact faces that face the door-side contact face when the opening portion is blocked, the cushion element surrounding the opening portion when the cushion element comes into contact with the door-side contact face and the opening-side contact faces.
